(19) United States
(12) Patent Application Publication
(10) Pub. No.: US 2015/0298593 A1
(43) Pub. Date: Oct. 22, 2015

(54) BOAT LIFT MOVING APPARATUS AND METHOD

(71) Applicants: Dennis R. POLZIN, Victoria, MN (US); Robert J. POLZIN, Fairmont, MN (US)

(72) Inventors: Dennis R. POLZIN, Victoria, MN (US); Robert J. POLZIN, Fairmont, MN (US)

(21) Appl. No.: 14/257,788

(22) Filed: Apr. 21, 2014

(51) Int. Cl. B60P 1/02; B60P 1/54

(52) U.S. Cl. CPC B60P 1/02; B60P 1/5423

(57) ABSTRACT

A boatlift moving apparatus includes a floorless U-shaped frame having four corners. Wheels are attached to the U-shaped frame. A post or upright is associated with four points or corners on the frame. Each upright includes a winch and a line. The boatlift moving apparatus is moved so that a boatlift is positioned within the U-shaped frame. The free ends of the U-shaped frame are connected with a cross member, thus surrounding the boatlift. The lines are attached to the boatlift and winched upwardly to lift the boatlift with respect to the frame. The boatlift can be moved from a position in the water to a position on land or vice versa and then set down.

### TECHNICAL FIELD

Various embodiments described herein relate to a boat lift moving apparatus and a method for the same. More specifically, the boat lift moving apparatus includes a frame on wheels that includes uprights for engaging the corners of the boat lift. The uprights are used to lift the boat lift with respect to the frame so the boat lift no longer sits on a surface. The wheels can then be used to move the frame and the boat lift.

### BACKGROUND

Many types of boat lifts have been provided for raising a boat above water level adjacent a dock or the like. Normally, the boat lifts have a frame that includes four corner legs. The corner legs each of which have an outer leg member with an inner leg member. The inner leg member are slidably mounted in the outer leg member. The inner leg member and the outer leg member are adjustable with respect to one another. The inner leg can be pinned to one of several positions with respect to the outer leg. In this way, the legs at each of the corners of the frame can be adjusted to compensate for irregularities in the bottom of the body of water in which the boat lift is situated. Normally, the inner leg members are adjusted with respect to the outer leg members by means of a pin extending through the outer leg member and one of several vertically spaced openings formed in the inner leg member. The adjustment pins are normally located beneath the water surface of the water in which the boat lift is positioned and a person must dive into the water to gain access to the adjustment pins.

The boat lift also includes a mechanism that includes a cradle for a boat. The cradle is moved up and down with respect to the frame of the boat lift to move a boat in the cradle from a position within the water to a position out of the water. The mechanism can be manual or can be powered, such as by an electrical motor.

In Northern climates, the bodies of water in which boats operates can freeze. For example, in the states of Minnesota, Wisconsin, North Dakota, and South Dakota it is not uncommon to have a foot of ice on a lake. In colder years, the ice can be thicker. Ice typically moves and heaves or whatever during a typical winter. If one were to leave a boat dock or a boat lift in the water for the winter, the ice wrecks havoc on such structures. Large forces are generated. In most instances, the forces bend or otherwise break steel or aluminum docks and steel or aluminum boat lifts. As a result, in these Northern climates, boat lifts and boat docks are generally moved out of the water in the fall and into the water after “ice out” in the spring or early summer.

Docks generally come apart and can be moved in sections. The sections do not weigh as much as the entire dock, so the sections are more easily moved into the water after “ice out” in the spring, and out the water before a lake or other body of water freezes in the fall.

A boat lift is assembled so that it does not come apart. As a result, the entire boat lift must be moved into and out of the body of water. Boat lifts are very heavy and many times are in fairly deep water. Therefore, it is not very practical for a bunch of workers to carry a boat lift into the water and to a position near a dock, Similarly, it is not practical to have a bunch of workers to move the boat lift out of the water in the fall. To ease moving a boat lift, pontoons or other inflatables have been developed which can be placed below the frame and between the bottom surface of the lake or other body of water, and the frame. The inflatables are inflated to float the boat lift from a position in shallow water to a final position. The inflatables can also be used to float a boat lift from its operating position to shallow water. The floats can not be used to float the boat lift in shallow water.

Removing the boat lift from a body of water requires that the boat lift be totally out of the water. Thus, when removing the boat lift, the structure is dragged to a winter resting spot. Dragging the boat lift can place large loads onto the adjustable legs of the boat lift. It is not uncommon to bend one or more legs of a boatlift. These legs then need to be repaired before placing the boat lift into the water in the spring. This can cost hundreds of dollars in repair bills. Furthermore, if the dragging is done by people, this is hard on one's body. Such an operation can also give rise to wear and tear on the mover's bodies, and in some instances might result in large medical bills. Therefore, there is a need for roving the boatlifts to or from shallow water that lowers the risk of bending a leg and which lowers the risk of high medical bills.

### SUMMARY OF THE INVENTION

A boatlift moving apparatus includes a floorless U-shaped frame having four corners. The U-shaped frame has a first leg, a second leg, and a cross member. A first upright is positioned near a first corner. A first winch is positioned on the first upright. A second upright is positioned near a second corner, and a second winch is positioned on the first upright. A third upright is positioned near a third corner, and a third winch positioned on the third upright. A fourth upright is positioned near a fourth corner, and a fourth winch positioned on the fourth upright. A line is attached to each of the winches. Each line has one end attached to the winch and another end adapted to be attached to a boat lift. A first wheel attached to the first leg, and a second wheel attached to the second leg. The U-shaped frame sized to fit around the boat lift. A spacer maintains the space between the free ends of the U-shaped frame. The boatlift moving apparatus is positioned around the boatlift, the lines are attached to the boatlift and are used to lift the boatlift with respect to the boatlift moving apparatus. Once the boatlift is lifted, the boatlift moving apparatus can be moved along with the boatlift. The boatlift can be moved from a position in the water to a position on land, or vice versa. Once positioned as desired, the boatlift is lowered with respect to the boatlift moving apparatus and the spacer bar or cross member is removed. The boatlift moving apparatus is moved away leaving the boatlift in its desired position.

A method for moving a boatlift includes positioning a floorless, U-shaped boatlift moving apparatus around the boat lift, attaching lines to the boatlift, and lifting the boatlift from a resting position to a suspended position with the boatlifting apparatus using the lines attached to the boatlift. The method also includes placing a spacer or cross member to a set of attachment points on the U-shaped frame to prevent substantial movement between members of the U-shaped frame, and moving the boat lifting apparatus, moving the suspended boatlift from a first position to a second position, and lowering the boatlift when at the second position. The first position is either on land or in the water, and the second position is the opposite of the first position in most cases.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is a view of the edge of a lake at a resort having a number of boatlifts, according to an example embodiment.

FIG. 2 is a perspective view of a boatlift moving apparatus having a boatlift in a position for moving, according to an embodiment of the invention.

FIG. 3 a top view of the boatlift moving apparatus, according to an example embodiment.

FIG. 4 is a side view of the boatlift moving apparatus, according to an example embodiment.

FIG. 5 is a side view of upright or post as attached to the first leg of the U-shaped frame as viewed along line 5-5 in FIG. 4, according to an example embodiment.

FIG. 6 shows a side view of a j-shaped hook or J hook, according to an example embodiment.

FIG. 7 is a side view of a line that includes a j-shaped hook or J hook for attaching to a frame of the boatlift, according to an example embodiment.

FIG. 8 shows a side view of another hook 820 for attaching to a leg of a boatlift, according to an example embodiment.

FIG. 9 is a side view of a line that includes a hook attached to a leg of the boatlift which also includes a clamp to keep the hook from sliding, according to an example embodiment.

FIG. 10 is a front view of the boatlift moving apparatus with a bracket in a support position, according to an example embodiment.

FIG. 11 is a front view of the boatlift moving apparatus featuring a steering handle, according to an example embodiment.

FIG. 12 is a top view of the reinforcement connection portion for attaching the second leg of the U-shaped frame to the cross member of the U-shaped frame, according to an example embodiment.

FIG. 13 is a top view of spacer bar with an adjustment mechanism for maintaining the space between several of the uprights on the boatlift moving apparatus, according to an example embodiment.

FIG. 14 is a flowchart of a method for using a boatlift moving apparatus to move a boatlift, according to an example, according to an example embodiment.

FIG. 15 is a perspective view of the boatlift moving apparatus carrying a boatlift, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

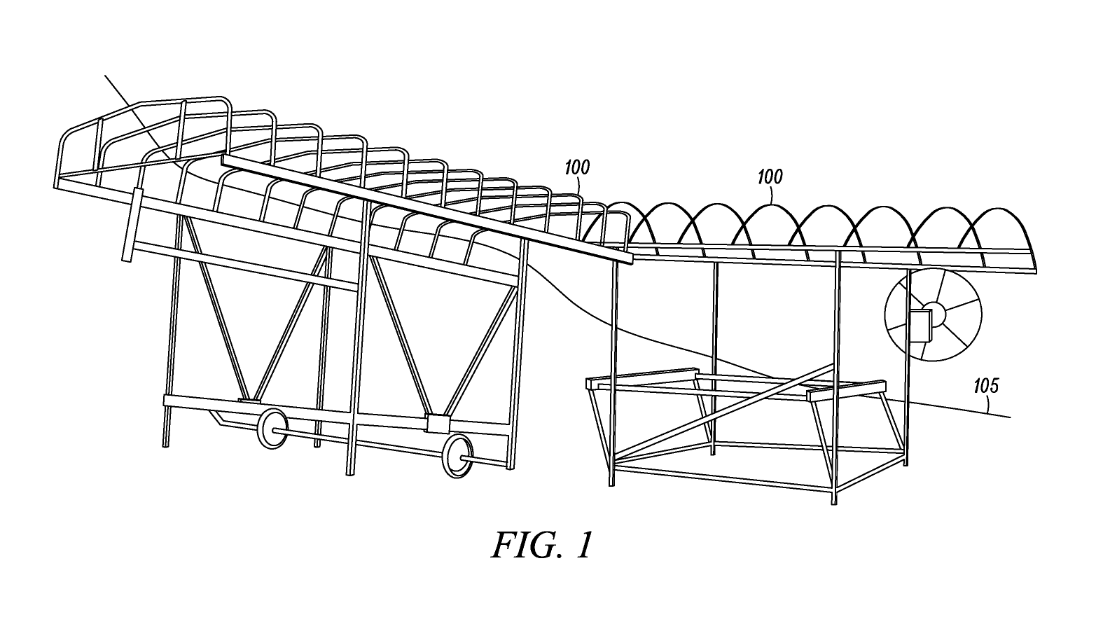

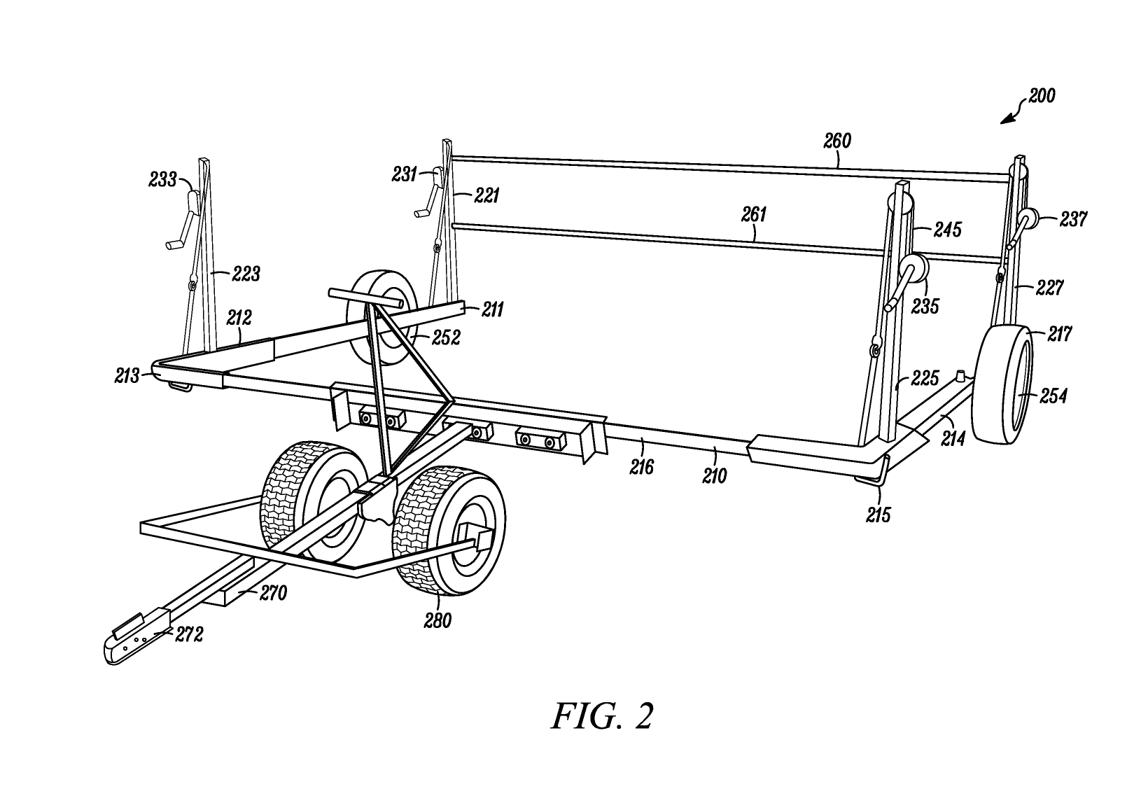

FIG. 1 is a view of the edge of a lake 105 or other body of water at a resort having a number of boatlifts 100, according to an example embodiment. As can be seen, the boatlifts 100 are stored on the beach or the edge of the lake 105 for the winter or for any other reason. In the springtime, the boatlifts 100 need to be moved back into the water where they will operate to temporarily lift boats out of the water during the boating season. At the end of the season, the boatlifts 100 will be moved from their position in the water to a position on land, such as shown in FIG. 1. The boatlift moving apparatus 200 (shown in FIG. 2 and following) is used to move a number of boatlifts 100 from a position at the edge of a lake or body of water 110 to a position in shallow water. Once in shallow water, bags can be attached to the frame of a boatlift, inflated to float the boatlift, and then the boatlift can be moved to a final or desired position within the lake. A lift barged can also be positioned under the boatlift and used to float the boatlift to a position in the water. At the end of the season, bags are again attached to the frame of the boatlift, inflated to float the boatlift, and the boatlift is moved to shallow water. A lift barge can also be used for the same purpose. It is contemplated that other lifting apparatus could also be used. The boatlift moving apparatus 200 is used to move one or more boatlifts 100 from shallow water to a position on land or vice versa. As mentioned above. In the past there was no good way to move the boatlift between shallow water and a position on land. In many instances, the boatlifts were dragged which results in a bent legs that are costly to repair. In addition, dragging requires brute force and so personnel might also be hurt resulting in medical bills for the people doing the work. It should be noted that the boatlift moving apparatus 200 can be used to move one boatlift at a time. In some instances, there may be only one boatlift or a few boatlifts on a cabin owners land. In such an instance a contractor may be called in to move the boatlift from the position on land to a position in the shallow water. There is really no need to have a plurality of boatlifts that need to be moved. In addition, the term boatlift includes a lift for any type of watercraft. The watercraft can be for large boats or for small boats, such as jet skis and the like.

FIG. 2 is a perspective view of a boatlift moving apparatus 200, according to an embodiment of the invention. The boatlift moving apparatus 200 includes a U-shaped frame 210. The U-shaped frame 210 has a first leg 212, a second leg 214, and a cross member 216. The U-shaped frame 210 has four corners 211, 213, 215, and 217. The U-shaped frame 210 does not have a floor or is floorless. A first upright 221 is positioned near a first corner 211. A first winch 231 is positioned on the first upright 221. A second upright 223 is positioned near a second corner 213, and a second winch 233 is positioned on the second upright 223. A third upright 225 is positioned near a third corner 215, and a third winch 235 positioned on the third upright 225. A fourth upright 227 is positioned near a fourth corner 217, and a fourth winch 237 positioned on the fourth upright 227.

A line is attached to each of the winches 231, 233, 235 and 237. For example, line 245 is attached to the winch 235. Each line has one end attached to the winch and another end adapted to be attached to a boat lift. The winch and line design will be further detailed in the discussion below.

A first wheel 252 is attached to the first leg 212 of the U-shaped frame 210, and a second wheel 254 attached to the second leg 214 of the U-shaped frame 210. The U-shaped frame 210 is sized to fit around a boat lift 100. It should be noted that the U-shaped frame 210 is generally sized to fit around a number of different types of boatlifts. The U-shaped frame is generally sized so that it can accommodate many types and models of boatlifts. The boatlift moving apparatus also includes a spacer bar 260. The spacer bar 260 is removed when placing the U-shaped frame 210 around a boatlift. After the U-shaped frame 210 is position around the boatlift, the spacer bar 260 is again placed between the uprights 231 and 237 to keep the distance between the first leg 212 and the second leg 214 of the frame 210 from varying substantially. In other words, the spacer 260 prevents the first leg 212 and the second leg 214 from spreading or constricting as the boatlift moving apparatus 200 moves the boatlift. Should be noted that there may be more than one spacer bar 260. For example, as shown in FIG. 2, there is an additional spacer bar 261. The boatlift moving apparatus 200, in one embodiment, also includes a spacer bar removably attached between the first leg 212 and the second leg 214 of the U-shaped frame 210. In some embodiments, the uprights 235, 237 can have a number of pairs of openings for receiving the spacer bar. The pairs of openings, are at different horizontal positions along the upright 235 and the upright 237. By having different horizontal positions, different types or models of boatlifts can be accommodated.

The spacer, in one embodiment, is removably attached between the second upright 231 and the third upright 237. The spacer, in this embodiment, is substantially parallel to the cross member 216 of the U-shaped frame 210. In another embodiment, the spacer is attached to at least two points on the boatlift moving apparatus. The spacer 260, 261 maintains the space between the first leg 212 and the second leg 214 of the U-shaped frame 210 of the boatlift moving apparatus 200. In still another embodiment, the spacer 260, 261 can be attached to one set of the attachment points to maintain the space between the first leg 212 and the second leg 214 of the U-shaped frame 200. In another embodiment, there are a plurality of sets of attachment points for the spacer. The spacer is attached to one set of the attachment points to maintain the space between the first leg and the second leg of the U-shaped frame. A set of the plurality of attachment points is selected so that spacer does not interfere with the boat lift being held by the boatlift moving apparatus. The plurality of sets of attachment points accommodates different models of boat lifts. Of course, different manufacturers have different models and there are a number of boatlift manufacturers as well.

The boatlift moving apparatus 200 also includes a tongue 270 attached to the U-shaped frame 210, and a hitch 272 attached to the tongue 270. The hitch 272 is hitchable to a vehicle sized to move the boat lifting apparatus 200 and a boatlift 100 suspended and held by the boat lifting apparatus 200. As shown in FIG. 2, a third steerable wheel 280 is attached to one of the frame 210 and the tongue 270. As shown in the embodiment of FIG. 2, the third steerable wheel 280 can include a pair of wheels. The boatlift moving apparatus 200 can be hitched to a vehicle. The vehicle can be moved her position around the boatlift 100 while the boatlift 100 is in the water or while the boatlift 100 is on land. The boatlift 100 can be suspended with respect to the boatlift moving apparatus 200 and the vehicle can be used to move the boatlift 100. The boatlift moving apparatus can be disconnected from the towing vehicle and the boatlift moving apparatus 200 can be steered by hand to a final or desired position. Once at the final or desired position, the boatlift 100 can be lowered and placed either onto the ground or into a position in shallow water.

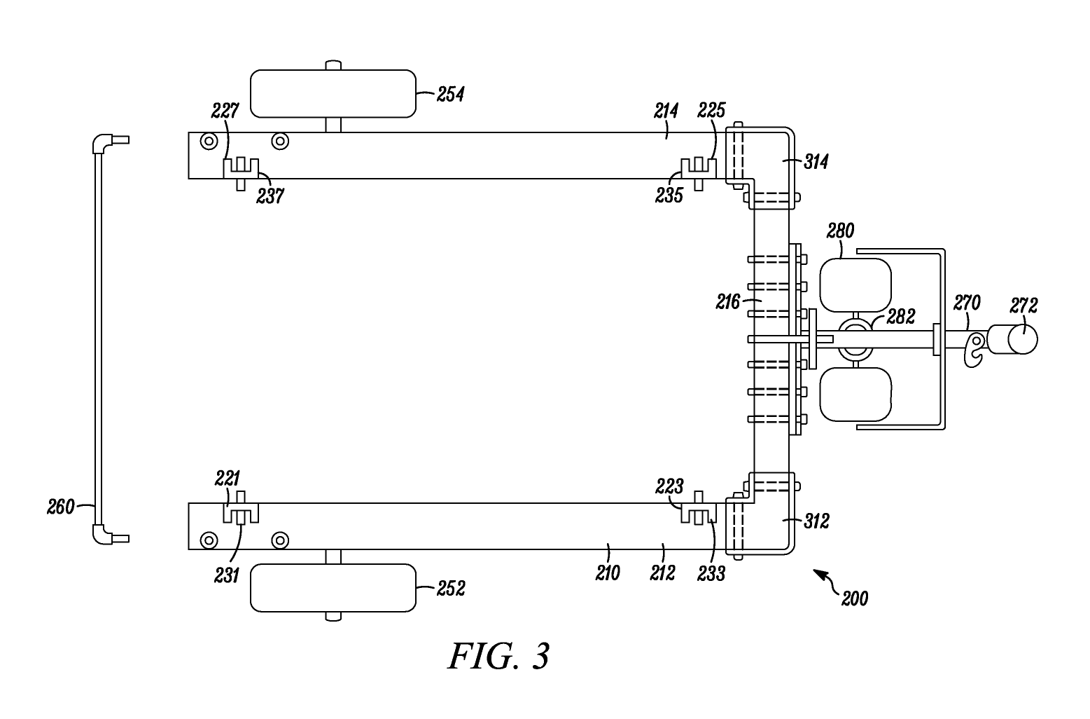

FIG. 3 a top view of the boatlift moving apparatus 200, according to an example embodiment. As shown, the boatlift moving apparatus 200 includes a U-shaped frame 210. The U-shaped frame 210 includes a first leg 212, a second leg 214, and a cross member 216. The spacing between the first leg 212 and the second leg 214 of the boatlift moving apparatus 200 is more closely spaced than the one shown in FIG. 2. The boatlift moving apparatus 200 also includes reinforcement sleeves 312 and 314. The reinforcement sleeves 312 and 314 strengthen the U-shaped frame 210. More specifically, the reinforcement sleeve 312 reinforces the joint between the first leg 212 and the cross member 216 of the U-shaped frame. The reinforcement sleeve 314 reinforces the joint between the second leg 214 and the cross member 216 of the U-shaped frame 210. Also shown is the tongue 270 and the hitch 272 which is attached to the tongue 270. The steerable wheel or wheels 280 are attached to the tongue 270 by a swivel 282. The uprights 221, 223, 225, and 227 and portions of the wenches 231, 233, 235, and 237 are also shown. Shown in an exploded position is the spacer bar 260. The spacer bar 260 inserts into openings in either the first leg 212 and the second leg 214, or into openings in the uprights 227 and 221.

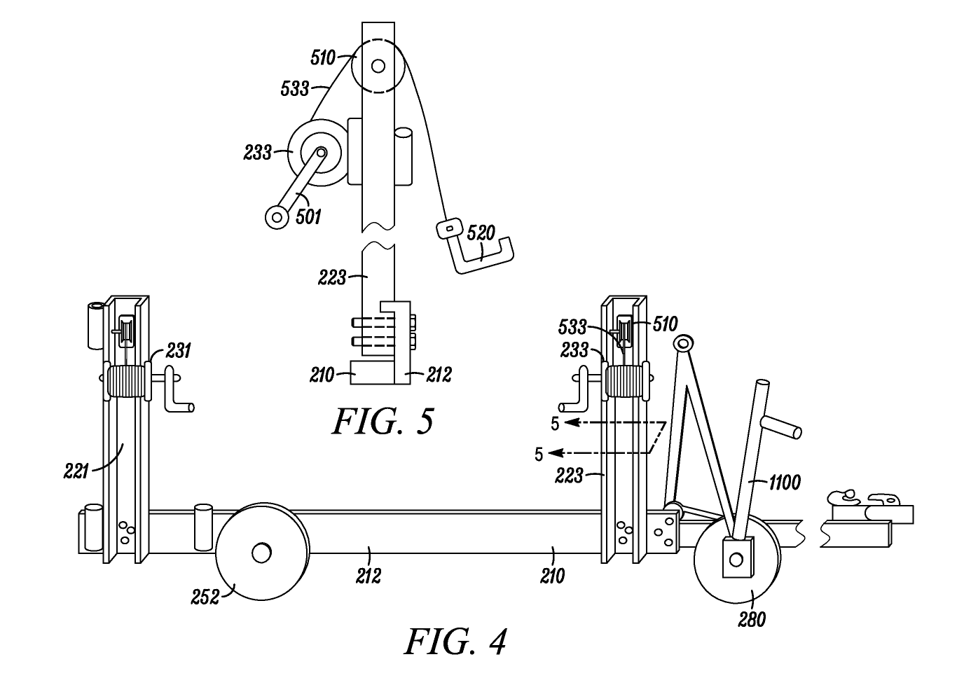

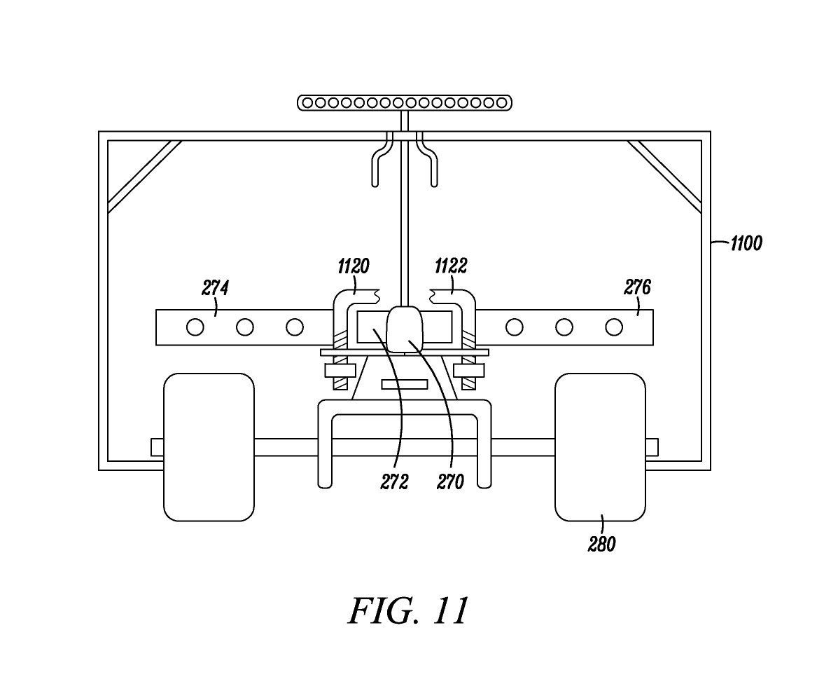

FIG. 4 is a side view of the boatlift moving apparatus 200, according to an example embodiment. Shown in more detail in FIG. 4, is the upright 221 and the upright 223 which carry winch 231 and winch 233, respectively. As shown, the upright 221 is connected to the first leg 212 by means of three fasteners and the upright 223 is connected to the first leg 212 by means of another three fasteners. FIG. 4 also shows that a portion of the rotatable or pivotable wheel system 280 can be folded into a storage position. Each winch, such as winch 233, includes a line 533 and a pulley 510. The foldable portion is a steering bar 1100. When in the upright position, the steering bar 1100 can be used to turn the rotatable or steerable wheel or wheel set 280. Steering is generally accomplished when the boatlift moving apparatus 200 is disconnected from the device used to move the boatlift moving apparatus 200, such as a tractor, four wheeler, or the like. When lowered, the steering bar enables a locking mechanism to prevent the steerable wheel 280 from rotating. The locking mechanism is further detailed and described in FIG. 11 below.

FIG. 5 is a side view of upright or post 223 as attached to the first leg 212 of the U-shaped frame 210 as viewed along line 5-5 in FIG. 4, according to an example embodiment. The winch 233 includes a handle 501 which is used to turn the winch 233. The winch includes a line or cable 533. One and of the line or cable 533 is attached to a school associated with the winch 233. The other end of the line or cable 533 is attached to a J hook 520. The J hook is sized so that it fits a number of frames associated with boat lifts or various boatlifts 100. The J hook 520 is one type of terminal hardware used to hook or non-permanently attached to the frame of a boatlift 100. Other types of terminal hardware could be used. The J hook 520 is one example of the type of terminal hardware. The line or cable 533 is positioned over the Pulley 510. As the handle 501 of the winch 233 is turned, the line or cable 533 is either let out or pulled in. When the line is being pulled in the J hook 520 engages the frame of the boatlift and lifts the boatlift with respect to the boatlift moving apparatus 200. Similarly, when the winch is operated to let line out, the boatlift 100 is lowered with respect to the U-shaped frame 210 of the boatlift moving apparatus 200. The J-shaped hook 520 is sized to attach to a frame of the boatlift and capable of lifting the boatlift. In other words, the J-hook 520 is substantial enough so that it will not fail with a load equal to or greater than the weight of the boat lift 100. It should be understood that the winch 233 may be geared to revive further mechanical advantage and provide a larger capability or capacity to raise a larger boatlift 100 with respect to the boatlift moving apparatus 200. Furthermore, the Pulley 510 could be replaced with a block and tackle or other similar hardware to provide further lifting capabilities or capacities to the winch assembly. As mentioned above, the J hook 520 can also be replaced with another type of terminal hardware that is capable of attaching to the frame of a boatlift 100.

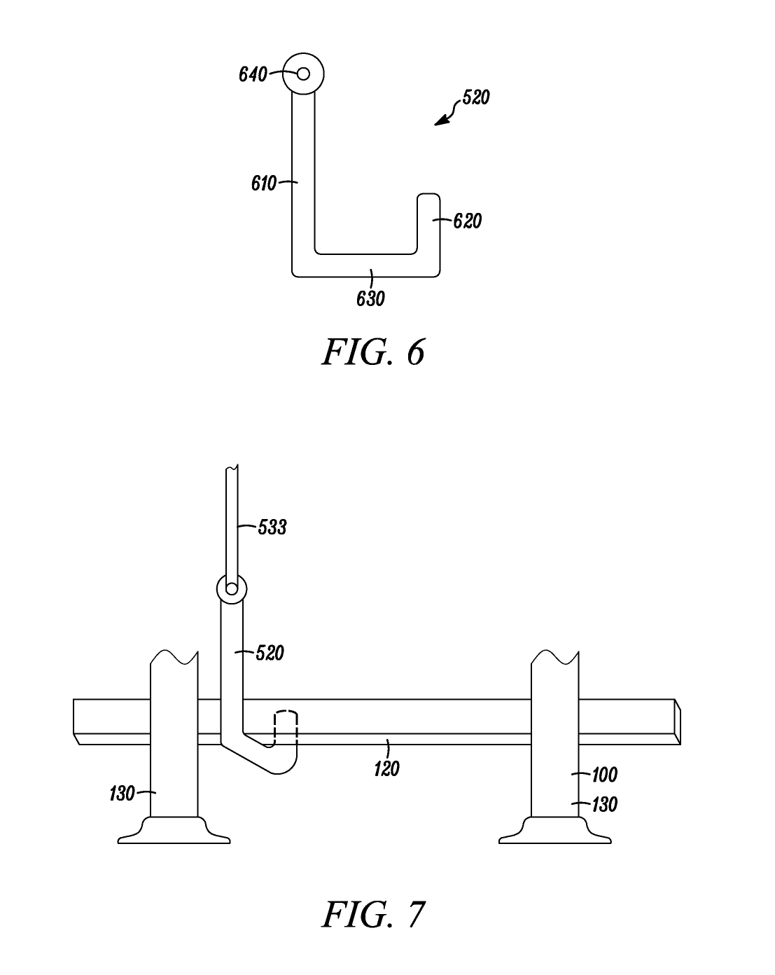

FIG. 6 shows a side view of a j-shaped hook or J hook 520, according to an example embodiment. FIG. 7 is a side view of a line that includes a j-shaped hook or J hook 520 for attaching to a frame 120 of the boatlift 100, according to an example embodiment. Now referring to both FIGS. 6 and 7, the J hook 520 will be further detailed. The J hook includes a long leg 610 and a short leg 620 which are attached by a cross member 630. The long leg 610 includes an eyelet 640. The eyelet 640 is sized to receive a line or cable, such as line or cable 533. As shown in FIG. 7, the J hook 520 is attached to the frame 120 of the boatlift 100. The boatlift 100 includes legs 130 which include enlarged ends for sitting on a soft surface, such as a lake bottom or the like.

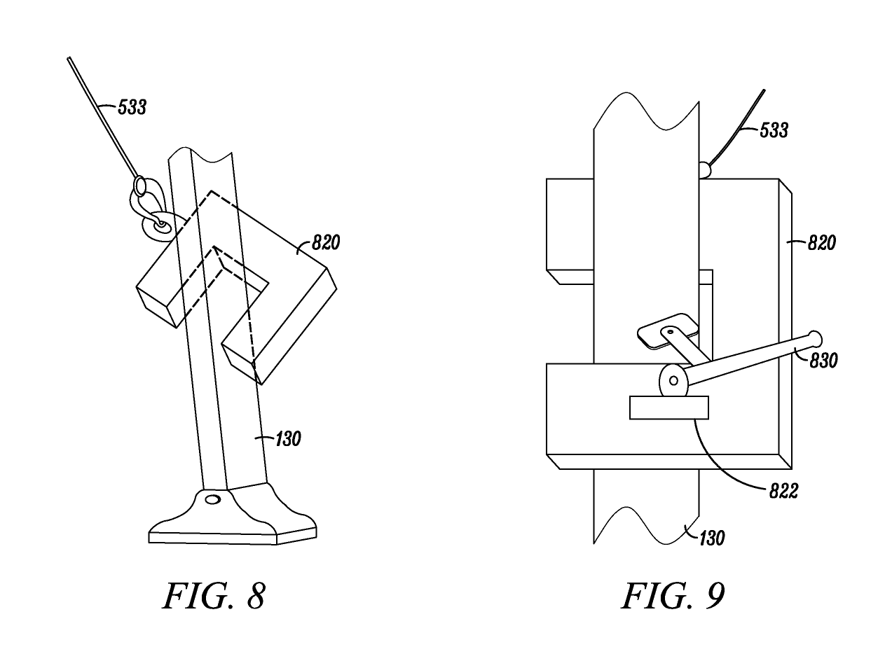

FIG. 8 shows a side view of another hook 820 for attaching to a leg 130 of a boatlift 100, according to an example embodiment. FIG. 9 is a side view of a line that includes a hook clamp portion or hook clamp 820 attached to a leg 130 of the boatlift 100 which also includes a clamp 132 to keep the hook clamp 820 from sliding, according to an example embodiment. The hook clamp 820 is another embodiment of the terminal hardware that can be used on the end of a line or cable, such as line or cable 533. In some instances, it can make more sense to attach to a leg 130 of a boatlift rather than to the frame of a boatlift. As shown, the hook clamp 820 includes a clamp receiving area 822. A clamp 830 is attached to the upright 130. The clamp 830 holds the hook 820 in place with respect to the leg 130 of the boatlift 100. As a load is applied to the hook clamp 820 such as while lifting the boatlift, the hook clamp 820 binds to the leg 130. The clamp 830 is used to inhibit movement along the length of the leg 130 so that the hook claim 820 binds at a desired point or near a desired area.

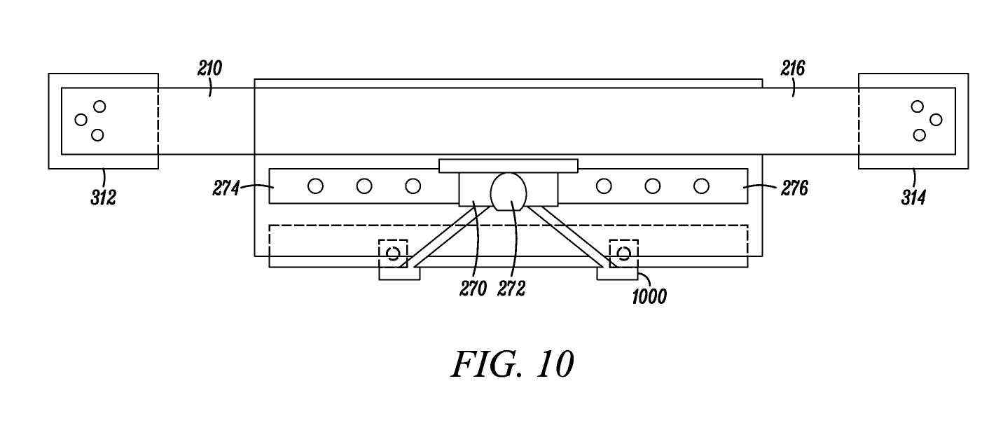

FIG. 10 is a front view of the boatlift moving apparatus 200 with a bracket 1000 in a support position, according to an example embodiment. Shown in FIG. 10 are the reinforcement areas 312 and 314. Also shown is that the tongue 270 is further reinforced by a first bracket 274 and a second bracket 276. The tongue 270 also includes a hitch 272. Attached below the hitch and to the tongue 270 is the bracket 1000. The bracket 1000 supports the tongue 270 when the hitch is detached from a towing vehicle.

FIG. 11 is a front view of the boatlift moving apparatus 200 featuring a steering handle 1100, according to an example embodiment. The steering handle 1100 is straight or nearly horizontal when the boatlift moving apparatus 200 is being pulled or pushed. The steering handle can fold up, as shown in FIG. 11, to enable steering of the steerable wheels or wheel 280 about the pivot or swivel 282 (shown in FIG. 3). When the steering handle 1100 is in the folded position, a user is able to more easily move the steerable wheels about the swivel 282. Typically, the steering handle 1100 is used to make final adjustments as the boatlift moving apparatus 200 is being moved to its final, intended destination. When the steering handle is lowered, locking elements 1120, 1122 engage the tongue of the boatlift moving apparatus and substantially prevent the steerable wheel or steerable wheel assembly 280 from rotating around the pivot 282 (shown in FIG. 3). The steerable wheels or steerable wheel assembly 280 is generally locked to a forward, non turning position.

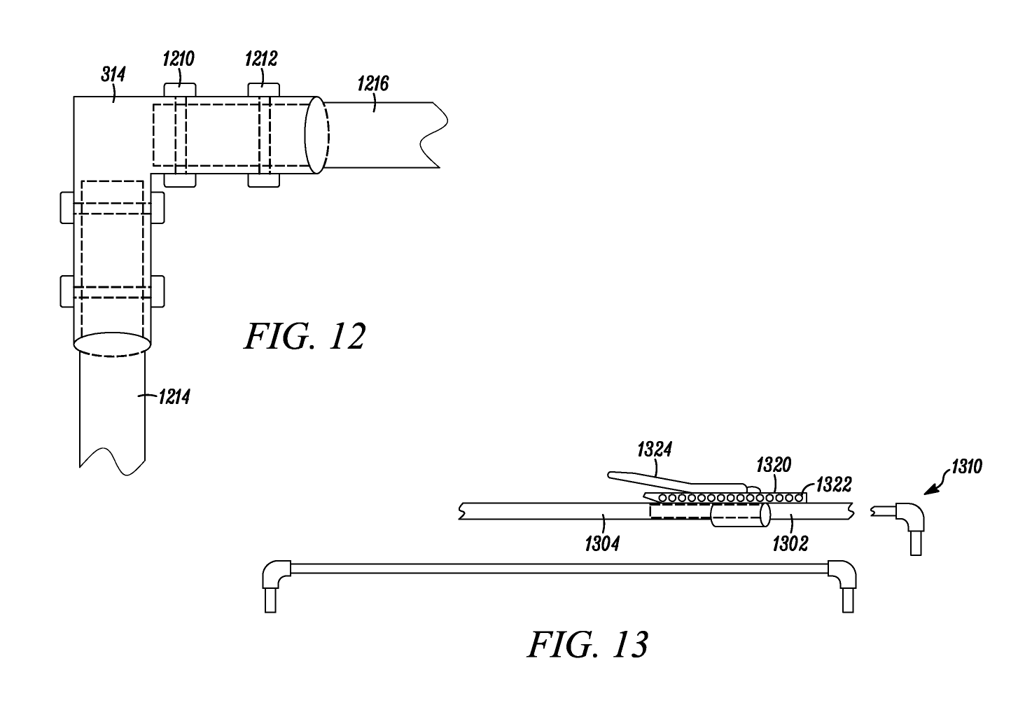

FIG. 12 is a top view of the reinforcement connection portion 314 for attaching the second leg 214 of the U-shaped frame to the cross member 216 of the U-shaped frame, according to an example embodiment. In this particular embodiment, the reinforcement portion 314 is welded to the first leg 214 and is attached by bolts or other fasteners 1210, 1212 to the cross member 216. The bolts or other fasteners 1210, 1212 can be removed so that the cross member 216 can slide in and out of the reinforcement portion 314. In another embodiment, the cross member 216 can be provided with slots having a width capable of receiving the bolts or other fasteners 1210, 1212. In this fashion, slight adjustments could be made to the length or position of the second leg 214 with respect to the cross member 216.

FIG. 13 is a top view of spacer bar 1310 with an adjustment mechanism 1320 for maintaining the space between several of the uprights on the boatlift moving apparatus, according to an example embodiment. The spacer bar 1310 includes a first bar 1302 which fits inside of a second bar 1304 includes an adjustment mechanism 1320. The adjustment mechanism 1320 includes a plate 1322 and a handle 1324. The plate 1322 acts as a wedge. The handle 1324 drives the plate 1322 into engagement with both the first bar 1302 and the second bar 1304. This holds or prevents motion between the first bar 1302 and the second bar 1304. At the end of the first bar 1302 is an elbow 1332 and that the end of the second part 1304 is a second elbow 1334. Extending from each of the elbows 1332, 1334 is a short piece which engages openings in either the upright posts or the first leg 212 and second leg 214 of the U-shaped frame 200 (shown in FIG. 2).

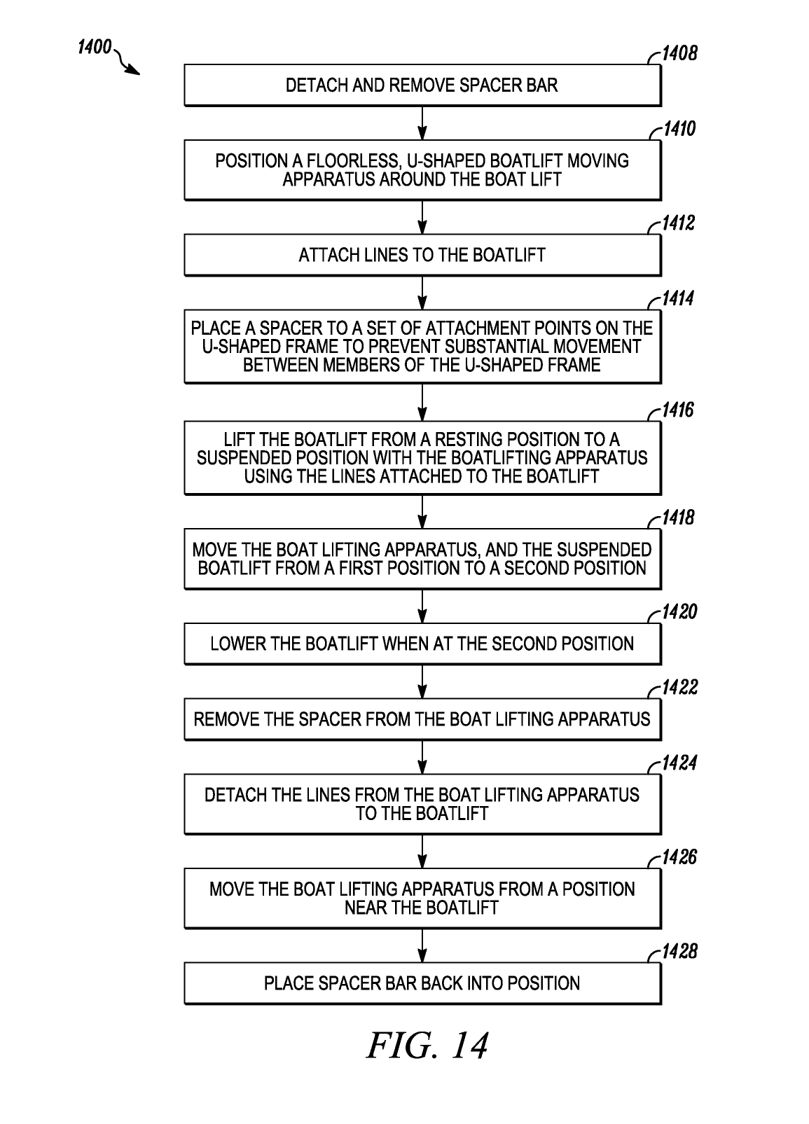

FIG. 14 is a flowchart of a method 1400 for using a boatlift moving apparatus 200 to move a boatlift 100, according to an example, according to an example embodiment. The method 1400 for moving a boatlift includes detaching and removing the spacer bar 1408, and positioning a floorless, U-shaped boatlift moving apparatus around the boat lift 1410, attaching lines to the boatlift 1412. The method 1400 also includes placing a spacer to a set of attachment points on the U-shaped frame to prevent substantial movement between members of the U-shaped frame 1414. The method 1400 also includes lifting the boatlift from a resting position to a suspended position with the boatlifting apparatus using the lines attached to the boatlift 1416, and moving the boat lifting apparatus, and the suspended boatlift from a first position to a second position 1418, and lowering the boatlift when at the second position 1420. The first position is either on land or in the water, and the second position is the opposite of the first position in most cases. The method 1400 also includes removing the spacer from the boat lifting apparatus 1422, detaching the lines from the boat lifting apparatus to the boatlift 1424, and moving the boat lifting apparatus from a position near the boatlift 1426. In other words, the boatlift moving apparatus no longer surrounds the boatlift. The spacer bar is then placed back into position where the spacer bar maintains the position of the first leg with respect to the second leg. Attaching lines to the boatlift 1412 includes attaching a J-shaped hook to the frame of the boatlift. The method 1400, in one embodiment, includes lifting boatlift from a resting position to the suspended position 1414 using at least one winch. The winches are attached to uprights associated with the U-shaped frame of the boatlifting apparatus. Lifting the boatlift from the resting position 1416 includes lifting a boatlift from shallow water or water near the edge of a lake or other body of water. Moving the boatlift can also include floating the boatlift from a second position in the water to a third position in deeper water.

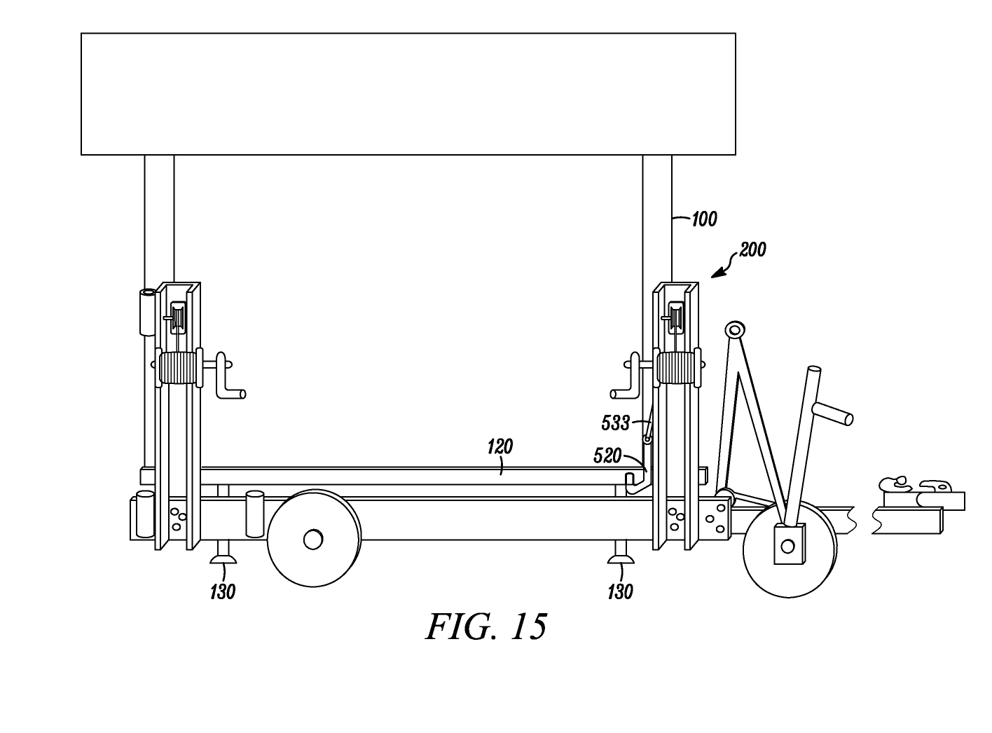

FIG. 15 is a perspective view of the boatlift moving apparatus 200 having a boatlift 100 in a position for moving, according to an example embodiment. The boatlift moving apparatus 200 has J-hooks 520 removably attached to the frame 120 of the boatlift 100. The boatlift 100 is elevated or lifted off the surface, as shown by the terminal portions of the legs being above the bottom of the tires associated with the boatlift moving apparatus.

It is contemplated that the boatlift moving apparatus 200 can be made out of different materials, such as steel or aluminum. Steel will be much heavier but more prone to the ravages of rust. Aluminum is lighter and rust resistant in that the layer of oxide formed on the surface of an aluminum objects inhibits or prevents further oxidation. The boatlift moving apparatus shown and described above is made from steel. It is also contemplated that a boatlift moving apparatus made of aluminum will require reinforcement in different places than those shown in the above described embodiments. Furthermore, certain members of such a moving apparatus may also have different dimensions to achieve the necessary strength needed. These are all considered within the scope of the invention.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed:

1. A boatlift moving apparatus comprising:
a floorless U-shaped frame having four corners, the U-shaped frame having:
a first leg;
a second leg; and
a cross member;
a first upright positioned near a first corner, a first winch positioned on the first upright;
a second upright positioned near a second corner, a second winch positioned on the first upright;
a third upright positioned near a third corner, a third winch positioned on the third upright;
a fourth upright positioned near a fourth corner, a fourth winch positioned on the fourth upright; and
a line attached to each of the winches, each line having one end attached to the winch and another end adapted to be attached to a boat lift;
a first wheel attached to the first leg; and
a second wheel attached to the second leg, the U-shaped frame sized to fit around the boat lift.

2. The boatlift moving apparatus of claim 1 wherein the other end of the line having the end adapted to be attached to a boat lift includes a hook to attach to a frame of the boatlift.

3. The boatlift moving apparatus of claim 1 wherein the other end of the line having the end adapted to be attached to a boat lift includes a J-shaped hook sized to attach to a frame of the boatlift and capable of lifting the boatlift.

4. The boatlift moving apparatus of claim 1 further comprising a hitch attached to the U-shaped frame, the hitch adapted to be removably attached to vehicle which is used to move the boatlift moving apparatus and a boatlift suspended with respect to the wheels of the boatlift moving apparatus.

5. The boatlift moving apparatus of claim 1 further comprising:
a tongue attached to the U-shaped frame; and
a hitch attached to the tongue, the hitch hitchable to a vehicle sized to move the boat lifting apparatus and a boatlift suspended and held by the boat lifting apparatus.

6. The boatlift moving apparatus of claim 1 further comprising:
a tongue attached to the U-shaped frame;
a hitch attached to the tongue, the hitch hitchable to a vehicle sized to move the boat lifting apparatus and a boatlift suspended and held by the boat lifting apparatus; and
a third steerable wheel attached to one of the frame and the tongue.

7. The boatlift moving apparatus of claim 1 further comprising a spacer removably attached between the first leg and the second leg of the frame.

8. The boatlift moving apparatus of claim 1 further comprising a spacer removably attached between the second upright and the third upright, the spacer being substantially parallel to the cross member of the U-shaped frame.

9. The boatlift moving apparatus of claim 1 further comprising a spacer attached to at least two points on the boatlift moving apparatus, the spacer maintaining the space between the first leg and the second leg of the U-shaped frame of the boatlift moving apparatus.

10. The boatlift moving apparatus of claim 9 wherein the boatlift moving apparatus has a plurality of sets of attachment points for the spacer, the spacer attached to one set of the attachment points to maintain the space between the first leg and the second leg of the U-shaped frame.

11. The boatlift moving apparatus of claim 9 wherein the boatlift moving apparatus has a plurality of sets of attachment points for the spacer, the spacer attached to one set of the attachment points to maintain the space between the first leg and the second leg of the U-shaped frame, wherein a set of the plurality of attachment points is selected so that spacer does not interfere with the boat lift being held by the boatlift moving apparatus.

12. A method for moving a boatlift comprising:
positioning a floorless, U-shaped boatlift moving apparatus around the boat lift;
attaching lines to the boatlift;
lifting the boatlift from a resting position to a suspended position with the boatlifting apparatus using the lines attached to the boatlift;
placing a spacer to a set of attachment points on the U-shaped frame to prevent substantial movement between members of the U-shaped frame;
moving the boat lifting apparatus and the suspended boatlift from a first position to a second position;
lowering the boatlift when at the second position;
detaching the lines from the boat lifting apparatus to the boatlift;
removing the spacer from the boat lifting apparatus;
moving the boat lifting apparatus from a position near the boatlift.

13. The method for moving a boatlift of claim 12 wherein attaching lines to the boatlift includes attaching a J-shaped hook to the frame of the boatlift.

14. The method for moving a boatlift wherein lifting boatlift from a resting position to the suspended position includes using at least one winch.

15. The method for moving a boatlift wherein lifting boatlift from a resting position to the suspended position includes using a plurality of winches attached to uprights associated with the U-shaped frame of the boatlifting apparatus.

16. The method for moving a boatlift wherein the lifting the boatlift from the resting position includes lifting a boatlift from shallow water.

17. The method for moving a boatlift further comprising floating the boatlift from a second position in the water to a third position in deeper water.
